(19) United States
(12) Patent Application Publication
(10) Pub. No.: US 2010/0098186 A1
(43) Pub. Date: Apr. 22, 2010

(54) UWB AMPLIFIER

(76) Inventor: Duncan Bremner, Lochwinnoch (GB)

Correspondence Address: REED SMITH LLP, P.O. BOX 488, PITTSBURGH, PA, 15230-0488, US

(21) Appl. No.: 12/520,512

(22) PCT Filed: Dec. 17, 2007
(86) PCT No.: PCT/GB07/04841

§ 371 Date: Nov. 18, 2009

(30) Foreign Application Priority Data
Dec. 21, 2006 (GB) 0625580.6

(51) Int. Cl. H04L 1/02

(52) U.S. Cl. 375/267

(57) ABSTRACT

A wireless communication device comprises an integrated circuit comprising electronic circuitry for performing wireless control functions. An external circuit, separate from the integrated circuit, is provided for performing a predetermined stage of a wireless control function, the external circuit comprising at least one discrete component. The at least one discrete component of the external circuit is controlled by one or more control signals received from the integrated circuit. As such, the invention makes use of a low cost external device as the input device in an integrated solution, thus benefiting from the improved performance of the external device while gaining the control and system benefits of a complex integrated solution.

### FIELD OF THE INVENTION

The invention relates to a wireless communication device, for example an ultra-wideband receiver and/or transmitter, and to a method of optimising performance in a wireless communication device. In particular, the invention relates to a wireless communication device comprising a wireless integrated circuit having an external circuit component, for example a Low Noise Amplifier (LNA) or an external low noise amplifying device, for providing optimum performance in the wireless communication device.

### BACKGROUND OF THE INVENTION

Ultra-wideband is a radio technology that transmits digital data across a very wide frequency range, 3.1 to 10.6 GHz. It makes use of ultra low transmission power, typically less than −41 dBm/MHz, so that the technology can literally hide under other transmission frequencies such as existing Wi-Fi, GSM and Bluetooth. This means that ultra-wideband can co-exist with other radio frequency technologies. However, this has the limitation of limiting communication to distances of typically 5 to 20 metres.

There are two approaches to UWB: the time-domain approach, which constructs a signal from pulse waveforms with UWB properties, and a frequency-domain modulation approach using conventional FFT-based Orthogonal Frequency Division Multiplexing

(OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 20 m of one another.

FIG. 1 shows the arrangement of frequency bands in a multi-band orthogonal frequency division multiplexing (MB-OFDM) system for ultra-wideband communication. The MB-OFDM system comprises fourteen sub-bands of 528 MHz each, and uses frequency hopping every 312 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organized into five band groups: four having three 528 MHz sub-bands, and one having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The basic timing structure of a UWB system is a superframe. A superframe consists of 256 medium access slots (MAS), where each MAS has a defined duration, for example 256 μs. Each superframe starts with a Beacon Period, which lasts one or more contiguous MASs. The start of the first MAS in the beacon period is known as the “beacon period start”. FIG. 2 shows the structure of a superframe where each of these MASs may be occupied by a different client located at varying distances from the receiver and with varying signal strengths (as shown in FIG. 3).

The technical properties of ultra-wideband mean that it is being deployed for applications in the field of data communications. For examₚle, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

An important factor in any UWB system is the noise performance of the UWB receiver. The input noise of a wireless receiver is mainly influenced by the gain of the first amplifying device in the chain. When the first amplifying device forms part of an integrated circuit, i.e. fully integrated in a silicon integrated process, the noise performance of such an integrated device is not as superior as the noise performance of an equivalent external device, which can have higher performance at a lower cost (regardless of whether these are simple discrete devices or more complex subsystems). Furthermore, it is possible to influence the selection of these external devices for a defined application environment thus permitting, say, the selection of a lower performance device for general use, but choosing a very high performance for a critical application. Offering this choice to users greatly enhances the commercial and technical viability of the overall system performance, while the additional cost of including control registers internally is minimal.

It is known to use a complete external discrete amplifier circuit to pre-amplify a signal prior to applying said signal to a lower performance CMOS only integrated device. However, these external amplifiers are separate (and complete) circuit entities. This limits the overall system versatility, such as rapid gain changes after a frequency channel change. A key requirement of UWB systems is to enable such a capability in less than 10 ns. The conventional approach suffers from the disadvantage that the CMOS system chip has no control over the external discrete amplifier circuit. Presently, the only method of achieving this level of performance is to fully integrate the amplifying device within the integrated circuit.

Another known approach is to use a hybrid integrated process such that the amplifying device may be integrated into a hybrid Bipolar-CMOS device. This is unattractive because the integrated performance of such a device is inferior compared with that of an external device due to processing compromises. Furthermore, by using the more complex and therefore expensive process for these two-three high performance devices, the entire solution carries the burden of the processing cost penalty, thus making the solution commercially less attractive.

It is an aim of the present invention to provide a wireless communication device that does not suffer from the disadvantages mentioned above.

### SUMMARY OF THE INVENTION

According to a first aspect of the present invention, there is provided a wireless communication device comprising: an integrated circuit comprising electronic circuitry for performing wireless control functions; an external circuit, separate from the integrated circuit, comprising means for performing a predetermined stage of a wireless control function, the external circuit comprising at least one discrete component; and wherein the at least one discrete component of the external circuit is controlled by one or more control signals received from the integrated circuit.

According to a further aspect of the present invention, there is provided a method of optimising performance in a wireless communication device. The method comprises the steps of: providing an integrated circuit comprising electronic circuitry for performing wireless control functions; providing an external circuit, separate from the integrated circuit, for performing a predetermined stage of a wireless control function, the external circuit comprising at least one discrete component; and controlling the at least one discrete component of the external circuit using one or more control signals received from the integrated circuit.

As can be seen, the invention makes use of a low cost external device as the input device in an integrated solution, thus benefiting from the improved performance of the external device while gaining the control and system benefits of a complex integrated solution. Further, the ability of the invention to optimise the choice of external devices, and provide internal registers to optimise the operation of these devices according to the user application provides additional benefit.

### BRIEF DESCRIPTION OF THE DRAWINGS

For a better understanding of the present invention, and to show more clearly how it may be carried into effect, reference will now be made, by way of example only, to the following drawings in which:

FIG. 1 shows the multi-band OFDM alliance (MBOA) approved frequency spectrum of a MB-OFDM system;

FIG. 2 shows the structure of a superframe where each Medium Access Slot (MAS) may be occupied by a different client located at varying distances from the receiver;

FIG. 3 shows how different Medium Access Slots relating to different clients located at varying distances from the receiver have varying signal strengths; and

FIG. 4 shows a wireless communication device according to an embodiment of the present invention.

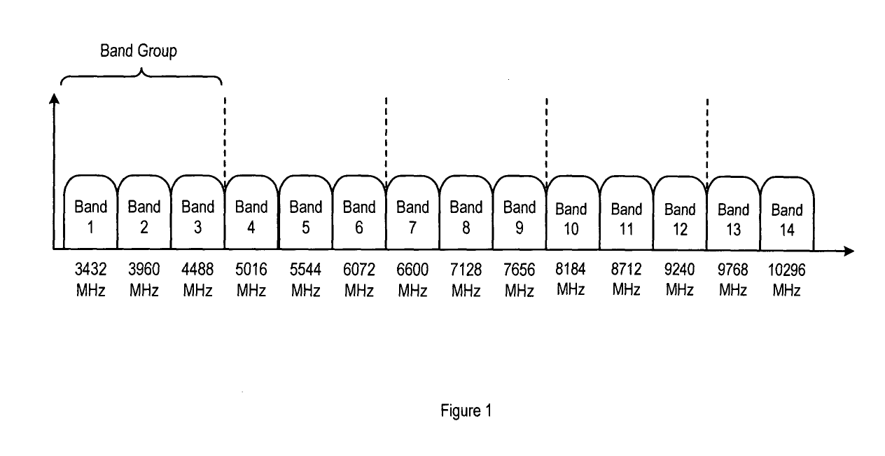

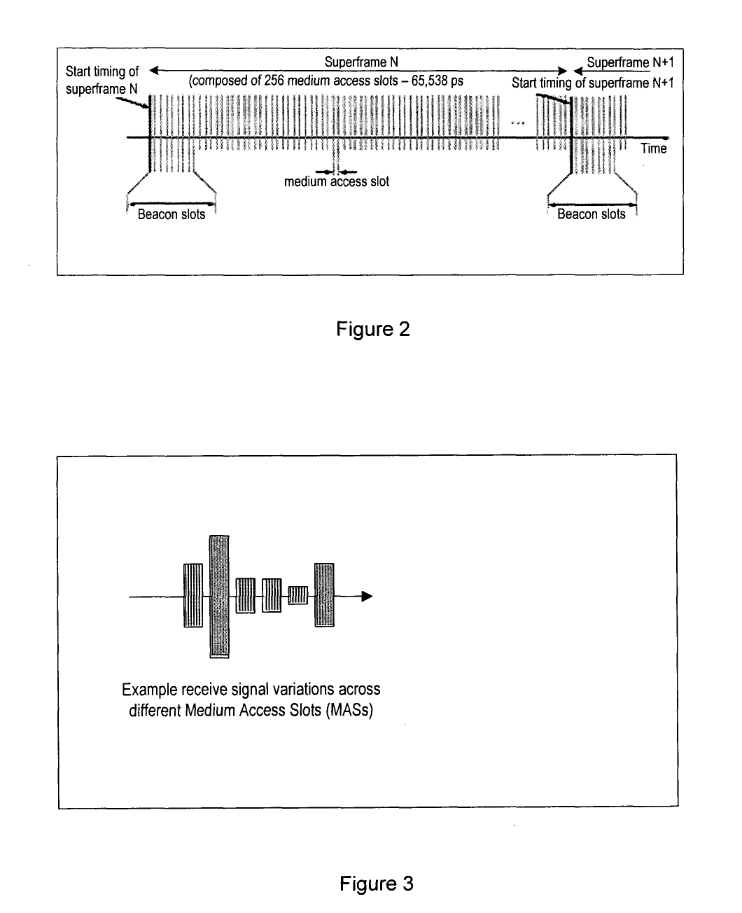

### DETAILED DESCRIPTION OF A PREFERRED EMBODIMENT OF THE PRESENT INVENTION

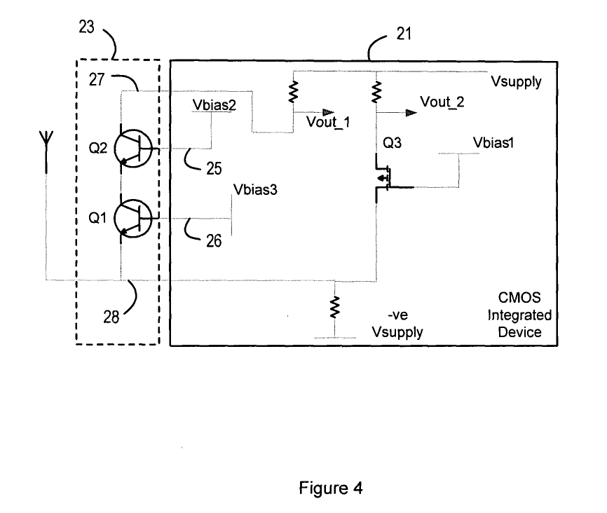

FIG. 4 shows a wireless communication device in the form of a wireless receiver according to an exemplary embodiment of the present invention. Although the preferred embodiment will be described in the context of a wireless receiver, it will be appreciated that the invention is also applicable to a wireless transmitter and a wireless transceiver (i.e. transmitter/receiver).

The wireless receiver comprises an integrated circuit 21 for performing wireless control functions. The integrated circuit is preferably formed using CMOS technology, although the invention is equally applicable to other technologies used for creating integrated circuits.

An external circuit 23 comprises discrete components, Q1, Q2. In an example application, the external circuit 23 is configured to form at least part of an external low noise gain circuit, for example a Low Noise Amplifier. It will be appreciated, however, that the external circuit 23 may be configured to perform other functions. By way of example, the anticipated functionality of the CMOS device 21 would integrate functions of a radio receiver such as further gain stages of the Low Noise Amplifier, mixer, oscillator and baseband processor. In addition to these functions, the inclusion of circuitry and registers to bias and control the external circuit 23 would also be included.

The discrete components Q1, Q2 of the external circuit 23 may be formed using bi-polar or similar technologies depending on application. In some applications the discrete components Q1, Q2 may be formed using a GaAs process. In this way, the discrete external components alone can be formed using a GaAs process, without requiring the need for the integrated circuit to be adapted to incorporate such a process. The components Q1, Q2 of the external circuit 23 are controlled using control signals 25, 26, 27 and 28 received from within the integrated circuit 21. It will be appreciated that, although the exemplary embodiment shows the external circuit 23 comprising first and second devices Q1, Q2, the external circuit may comprise any form of circuit, ranging from a single discrete component to a complex sub system. It will also be appreciated that these external components may be configured as an optimised subsystem controlled by the lower cost CMOS device, thus enabling greater performance to be achieved.

In the example, by controlling the DC operating point of the external devices Q1, Q2 from internal control circuitry, these devices may be adjusted to operate at their optimum conditions for maximum system performance. As mentioned above, in addition to the above example, it is possible to design a system such that a more complex external circuit 23 may be realised externally, such that any variations of this external circuit due to on-chip/off-chip mismatching, temperature variations, etc., can be reduced using the low cost integrated circuit 21. In the example of FIG. 4, the external low noise gain circuit is configured as a two transistor cascade gain stage coupled with an internal differential gain device (Q3) in order to realise an amplification function. In this configuration, it is important to control the DC operating points of the external devices such that optimum bias conditions are applied to avoid non-linear behaviour. These conditions vary according to external influences such as temperature or process variations. Therefore, the operating conditions must be adjusted according to internal circuitry such that the devices are always operating correctly. These adjustments must be made according to the voltages on the nodes of the devices attached to the control circuit and according to some previously pre-determined calculations. These calculations may be programmed into the control circuit in well known ways.

The wireless receiver may be used, for example, to communicate with a multitude of clients, each occupying a relatively short time slot. In such a system it is important that the RF wireless system is capable of responding to rapidly changing operating conditions, hence device operating points, on a per client basis. Furthermore, given this constraint, it is important that power consumption of the system is always optimised to conserve power, decrease noise, or improve the signal handling performance according to the needs of each client. Since the control of the input device (i.e. the external circuitry 23) is directly managed by the CMOS control device (i.e. the integrated circuit 21), these changes can be carried out very rapidly. If the input device is connected to the control device using DC blocking components, the transient response time of these do not permit fast slewing of the operating point due to the recovery time of the blocking components. By controlling the operating point of the input device via the CMOS control circuit, and avoiding the need for DC blocking components, very fast changes are possible.

The invention has the advantage that it permits the use of a low cost CMOS only process for the wireless system control functions plus a dedicated, simple, low cost, optimised low noise external device as the first receiver gain stage which is under the control of the CMOS wireless system chip. The external circuit 23 has its operational parameters controlled either completely or in a hybrid fashion such that the operation of the external circuit 23 is either partly or wholly under the control of the lower cost integrated circuit 21, i.e. the CMOS control circuit.

In addition, by incorporating the control circuitry within the integrated circuit 21, very fast changes to the operating point can be achieved, which lead to system benefits when switching between low and high level received signal cases. Since the external circuit 23 is effectively an external part of the CMOS control device 21, the speed at which the operating point of the external circuit 23 can be changed is predominantly governed by the CMOS control circuit 21.

According to another aspect of the invention, the external circuit 23 can be a duplicate of a circuit found within the integrated circuit 21 (or a circuit that performs substantially the same function as a circuit found within the integrated circuit 21). Therefore, in applications where the performance of the CMOS device alone will suffice, the wireless receiver is capable of being implemented without using the external circuit 23. This permits an internal circuit, which is basically the same as the external circuit, to be used in applications where a lower performance is acceptable. As such, the external circuit 23 can selectively form part of the operation of the integrated circuit, depending upon whether an improved performance is required. In practice the implementation of such an arrangement may be such that the configuration of the integrated circuit 21 allows removal of the external circuit 23. This may require the resetting of some internal control registers. However, the physical layout of the system is preferably designed such that a minimum number of components, preferably none, require changing in order to operate in this second mode.

It will be appreciated that a key functional benefit of the invention is to incorporate the bias and/or control of the external low noise device (i.e. the external circuit 23) into the complex system device (i.e. the integrated circuit 21), thus benefiting from the performance and economic benefits while simultaneously being able to control this external element accurately with the CMOS circuit. It is noted that the bias and/or control provided by the integrated circuit may be based on one or more signals passed from the external device 23 to the integrated circuit 21.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A wireless communication device comprising:
an integrated circuit comprising electronic circuitry for performing wireless control functions;
an external circuit, separate from the integrated circuit, comprising means for performing a predetermined stage of a wireless control function, the external circuit comprising at least one discrete component; and
wherein the at least one discrete component of the external circuit is controlled by one or more control signals received from the integrated circuit.

2. A wireless device as claimed in claim 1, wherein the integrated circuit is configured to provide at least one of the following to the external circuit based on at least one signal received from the external circuit:
a bias signal; and
a control signal.

3. A wireless device as claimed in claim 1, wherein the external circuit forms at least part of an amplifier device.

4. A wireless device as claimed in claim 3, wherein the external circuit forms at least part of a low noise amplifier device.

5. A wireless device as claimed in claim 1, wherein the external circuit performs substantially the same function as a circuit found within the integrated circuit.

6. A wireless device as claimed in claim 5, wherein the external circuit is selectively operated.

7. A wireless device as claimed in claim 1, wherein the integrated circuit is configured for reducing variations in the external circuit due to at least one of the following:
on-chip/off-chip mismatching; and
a temperature difference between the integrated circuit and the external circuit.

8. A wireless device as claimed in claim 1, wherein the external circuit is configured to have its operational parameters controlled at least in part by the integrated circuit.

9. A wireless device as claimed in claim 1, wherein the integrated circuit comprises one or more internal registers for controlling the external circuit.

10. A wireless device as claimed in claim 1, wherein the at least one discrete component of the external circuit is formed using one of the following processes:
a bi-polar process; and
a GaAs process.

11. A wireless device as claimed in claim 1, wherein the integrated circuit is formed using a CMOS process.

12. A method of optimising performance in a wireless communication device, the method comprising the steps of:
providing an integrated circuit comprising electronic circuitry for performing wireless control functions;
providing an external circuit, separate from the integrated circuit, for performing a predetermined stage of a wireless control function, the external circuit comprising at least one discrete component; and
controlling the at least one discrete component of the external circuit using one or more control signals received from the integrated circuit.

13. A method as claimed in claim 12, wherein the external circuit forms at least part of an amplifier device.

14. A method as claimed in claim 12, wherein the external circuit forms at least part of a low noise amplifier device.

15. A method as claimed in claim 12, wherein the external circuit is operated to perform substantially the same function as a circuit also found within the integrated circuit.

16. A method as claimed in claim 15, wherein the external circuit is selectively operated.

17. A method as claimed in claim 12, further comprising the step of controlling the operation of the integrated circuit to reduce variations in the external circuit due to at least one of the following:
on-chip/off-chip mismatching: and
a temperature difference between the integrated circuit and the external circuit.

18. A method as claimed in claim 12, further comprising the step of controlling the external circuit such that the operational parameters of the external circuit are controlled at least in part by the integrated circuit.

19. A method as claimed in claim 12, further comprising the step of providing one or more internal registers in the integrated circuit for controlling the operation of the external circuit.

20. A method as claimed in claim 12, wherein the at least one discrete component of the external circuit is formed using a bi-polar or GaAs process.

21. A method as claimed in claim 12, wherein the integrated circuit is formed using a CMOS process.

22. An integrated circuit for use in a wireless communications device as claimed in claim 1.
